(19) United States
(12) Patent Application Publication
(10) Pub. No.: US 2022/0098521 A1
(43) Pub. Date: Mar. 31, 2022

(54) Concentrated Flowable Washing Agent Preparation Having Improved Properties

(71) Applicant: Henkel AG & Co. KGaA, Duesseldorf (DE)

(72) Inventors: Inga Kerstin Vockenroth, Duesseldorf (DE); Barbara Busch, Neuss (DE)

(21) Appl. No.: 17/486,720

(22) Filed: Sep. 27, 2021

(30) Foreign Application Priority Data
Sep. 25, 2020 (DE) 102020212100.1

(51) Int. Cl. C11D 3/34; C11D 1/22; C11D 1/83; C11D 3/20; C11D 1/72; C11D 11/00; C11D 17/00; C11D 17/04

(52) U.S. Cl. CPC C11D 3/3409; C11D 1/22; C11D 1/83; C11D 17/043; C11D 1/72; C11D 11/0017; C11D 17/0008; C11D 3/2075

(57) ABSTRACT

A flowable washing agent preparation containing, based on the total weight thereof, a) 4 to 8 wt. % alkyl ether sulfate; b) 5 to 14 wt. % fatty acid; c) less than 20 wt. % water; where the total amount of anionic and non-ionic surfactants contained in the washing agent preparation is 13 to 48 wt. %; and the washing agent preparation contains alkyl ether sulfate and fatty acid in a weight ratio of from 2:1 to 1:3, and textile washing methods using this washing agent preparation.

### FIELD OF THE INVENTION

The present invention relates to a surfactant-based washing agent preparation having a low water content. The application furthermore relates to washing agent portion units which comprise this washing agent preparation and a method for washing textiles using the washing agent preparation or the washing agent portion unit.

### BACKGROUND OF THE INVENTION

Continuously changing requirements are placed on the forms in which washing and cleaning agents are manufactured and sold. For some time, the consumer has paid special attention to the easy dosing of washing and cleaning agents by the consumer and the simplification of the operational steps required to carry out a washing or cleaning process. A technical solution is provided by pre-portioned washing or cleaning agents, for example film pouches having one or more receiving chambers for solid or liquid washing or cleaning agents.

A relevant trend for the production of these film pouches is the miniaturization of these film pouches. The background to this development is, in addition to higher consumer acceptance due to simplified handling, in particular sustainability aspects, for example with regard to transport volumes and costs and the amount of packaging means used.

The concentration of modern washing agents, in particular modern liquid washing agents, generally influences the optical and rheological properties thereof, affects the storage stability of these agents and can influence their cleaning performance, in particular if the high concentration of the active substances leads to incompatibilities.

### BRIEF SUMMARY OF THE INVENTION

The problem addressed by the application was that of providing visually appealing, concentrated, flowable washing agent preparations which can be produced in a simple and efficient manner, have a good storability and are characterized in particular by good cleaning results. In particular, the washing agent preparation should be able to be packaged in water-soluble sachets and should be based predominantly on ingredients which can be produced at least in part from renewable raw materials.

A first subject of the application is a flowable washing agent preparation containing, based on the total weight thereof,
a) 4 to 8 wt. % alkyl ether sulfate;
b) 5 to 14 wt. % fatty acid;
c) less than 20 wt. % water;
   where
the total amount of anionic and non-ionic surfactants contained in the washing agent preparation is 13 to 48 wt. %; and
the washing agent preparation contains alkyl ether sulfate and fatty acid in a weight ratio of from 2:1 to 1:3.

The washing agent preparation is flowable under standard conditions (20° C., 1013 mbar).

The washing agent preparations are surfactant-based. The proportion by weight of anionic and non-ionic surfactant in the total weight of the washing agent preparation is 13 to 48 wt. %, preferably is 35 to 45 wt. %.

The first essential components of the washing agent preparation are anionic and non-ionic surfactants, which are contained in the washing agent preparation in an amount from 13 to 48 wt. %, preferably 35 to 45 wt. %.

As an anionic surfactant, the washing agent preparation necessarily contains alkyl ether sulfate in a proportion by weight of the total weight of the washing agent preparation of 4 to 8 wt. %, preferably 5 to 7 wt. %.

In particular fatty alcohol ether sulfates from the group of sulfuric acid monoesters of straight-chain or branched C₇-C₂₁ alcohols ethoxylated with 1 to 6 mol ethylene oxide, such as 2-methyl-branched C₉₋₁₁ alcohols having, on average, 3.5 mol ethylene oxide (EO) or C₁₂-18 fatty alcohols having 1 to 4 EO, are preferably suitable as alkyl ether sulfates. Alkyl ether sulfates of formula (I) are preferred

R¹—O-(AO)ₙ—SO3-X⁺ (I)

In this formula (II), R¹ represents a linear or branched, substituted or unsubstituted alkyl functional group, preferably a linear, unsubstituted alkyl functional group, particularly preferably a fatty alcohol functional group. Preferred functional groups R¹ of formula (II) are selected from decyl, undecyl, dodecyl, tridecyl, tetradecyl, pentadecyl, hexadecyl, heptadecyl, octadecyl, nonadecyl, eicosyl functional groups and mixtures thereof, the representatives having an even number of C atoms being preferred. Particularly preferred functional groups R¹ of formula (II) are derived from fatty alcohols having 12 to 18 C atoms, for example from coconut fatty alcohol, tallow fatty alcohol, lauryl alcohol, myristyl alcohol, cetyl alcohol or stearyl alcohol, or from oxo alcohols having 10 to 20 C atoms.

In formula (A-1), AO represents an ethylene oxide (EO) or propylene oxide (PO) group, preferably an ethylene oxide group. The index n in formula (I) is an integer from 1 to 50, preferably from 1 to 20, and in particular from 2 to 10. Very particularly preferably, n is 2, 3, 4, 5, 6, 7 or 8. X is a monovalent cation or the nth part of an n-valent cation, the alkali metal ions, including Na⁺ or K⁺ and the amines, being preferred in this case, with Na⁺ and primary and secondary amines, in particular monoethanolamine, being extremely preferred. Further cations X⁺ may be selected from NH₄⁺, ½Zn²⁺, ½Mg²+, ½Ca²+, ½Mn²⁺, and mixtures thereof.

Particularly preferred compositions contain an alkyl ether sulfate selected from fatty alcohol ether sulfates of formula (I), where R¹=linear C12-18 alkyl, n=2, 3, 4, 5, 6, 7 or 8 and X⁺═Na⁺ or HOCH₂CH₂NH₃⁺. Very particularly preferred representatives are Na fatty alcohol ether sulfates or monoethanolamine fatty alcohol sulfates having 12 to 18 C atoms and 2 EO (R¹=linear C12-18 alkyl, n=2 in formula I).

### DETAILED DESCRIPTION OF THE INVENTION

The degree of ethoxylation indicated represents a statistical average which can correspond to an integer or a fractional number for a specific product. The degrees of alkoxylation indicated represent statistical averages which can correspond to an integer or a fractional number for a specific product. Preferred alkoxylates/ethoxylates have a narrowed homolog distribution (narrow range ethoxylates, NRE).

In addition to the alkyl ether sulfates described above, the washing agent preparation can contain further anionic surfactants. The group of these further surfactants includes, for example, the C₈₋₁₈ alkylbenzene sulfonates, in particular the C₉-C₁₃ alkylbenzene sulfonates, olefin sulfonates, C₁₂-C₁₈ alkane sulfonates, ester sulfonates, alk(en)yl sulfates and mixtures thereof.

For the cleaning action of the washing agent compositions, it has surprisingly proven to be advantageous if these, based on the total weight thereof, are less than 10 wt. %, preferably less than 5 wt. % and in particular less than 2 wt. % C₈₋₁₈ alkylbenzene sulfonates, in particular C₉-C₁₃ alkylbenzene sulfonates. Small proportions by weight of alkylbenzene sulfates are therefore preferred.

The use of fatty acids has proven to be advantageous for stability and cleaning performance. Preferred washing agent preparations therefore contain, based on the total weight thereof, 8 to 10 wt. %, preferably 6 to 10 wt. %, fatty acid. Particularly preferred fatty acids are selected from the group of caprylic acid, capric acid, lauric acid, myristic acid, palmitic acid, stearic acid, oleic acid, linoleic acid and mixtures thereof. In the context of the application, the fatty acids are included in the group of anionic surfactants.

For the cleaning performance of the washing agent compositions, it has proven to be advantageous for the washing agent preparation to contain alkyl ether sulfate and fatty acid in a weight ratio of from 1:1 to 1:2.

The washing agent preparations contain non-ionic surfactant. The proportion by weight of the non-ionic surfactant with respect to the total weight of the washing agent preparation is preferably 12 to 28 wt. % and in particular 15 to 25 wt. %.

The use of non-ionic surfactants from the group of alkyl ethoxylates has proven to be particularly advantageous technically. Preferred alkyl ethoxylates are selected from the group of ethoxylated primary C₈₋₁₈ alcohols, preferably the ethoxylated primary C₈₋₁₈ alcohols having a degree of alkoxylation of >4, particularly preferably the C₁₂₋₁₄ alcohols having 4 EO or 7 EO, the C₉₋₁₁ alcohols having 7 EO, the C₁₃₋₁₅ alcohols having 5 EO, 7 EO or 8 EO, the C₁₃-15 oxo alcohols having 7 EO, the C₁₂₋₁₈ alcohols having 5 EO or 7 EO, in particular the C₁₂₋₁₈ fatty alcohols having 7 EO or the C₁₃₋₁₅ oxo alcohols having 7 EO.

With regard to the rheological properties of the washing agent preparation and the processability and cleaning action thereof, it has proven advantageous to use non-ionic surfactant and non-ionic anionic surfactant in a weight ratio above 5:3, preferably above 3:2.

Preferred washing agent preparations contain, based on the total weight thereof, 15 to 45 wt. %, preferably 25 to 45 wt. %, of solvent. The solvent can be water, organic solvents or aqueous-organic solvent systems. The use of aqueous-organic solvent systems has proven to be particularly advantageous for manufacturability and storability and is therefore preferred.

In a preferred embodiment, the washing agent preparation contains, based on the total weight thereof, 15 to 42 wt. %, preferably 20 to 40 wt. % and in particular 22 to 35 wt. % organic solvent.

Preferred organic solvents are selected from the group of ethanol, n-propanol, i-propanol, butanols, glycol, propanediol, butanediol, methylpropanediol, glycerol, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol mono methyl ether, dipropylene glycol mono ethyl ether, methoxytriglycol, ethoxytriglycol, butoxytriglycol, 1-butoxyethoxy-2-propanol, 3-methyl-3-methoxybutanol, propylene-glycol-t-butyl ether, di-n-octylether and mixtures thereof, preferably from the group of propanediol, glycerol, ethanol and mixtures thereof.

The water content of preferred washing agent preparations is, based on the total weight thereof, less than 15 wt. %, preferably less than 10 wt. %, of water.

Preferred washing agent preparations contain phosphonate as an optional component. The proportion by weight of phosphonate with respect to the total weight of the washing agent preparation is preferably 0.1 to 3 wt. % and in particular 0.2 to 1 wt. %.

A hydroxy alkane phosphonate and/or amino alkane phosphonate is preferably used as a phosphonate compound. Among the hydroxy alkane phosphonates, 1-hydroxyethane-1,1-diphosphonate (HEDP) has particular significance. Possible amino alkane phosphonates preferably include ethylenediamine tetramethylene phosphonate (EDTMP), diethylenetriamine pentamethylene phosphonate (DTPMP) and the higher homologs thereof. The use of ethylenediamine tetramethylene phosphonate (EDTMP) and diethylenetriamine pentamethylene phosphonate (DTPMP) is very particularly preferred.

Preferred washing agent preparations contain an ethoxylated polyethyleneimine. Preferred ethoxylated polyethyleneimines are non-ionic, i.e. do not have any quaternary nitrogen atoms or other ionic groups than those which arise as a result of a protonation of the nitrogen atoms that is influenced by pH. The ethoxylated polyethyleneimine preferably comprises a polyethyleneimine basic structure which has been modified by ethoxylation, the ethoxylated polyethyleneimine having a weight-average molecular weight Mw in the range of from 300 g/mol to 10,000 g/mol.

Preferred washing agent preparations contain 2 to 8 wt. %, preferably 3 to 6 wt. %, enzyme preparation as a further optional component.

In addition to the actual enzyme protein, an enzyme preparation includes other components such as enzyme stabilizers, carrier materials or fillers. The enzyme protein in this case usually only forms a fraction of the total weight of the enzyme preparation. Preferably used enzyme preparations contain between 0.1 and 40 wt. %, preferably between 0.2 and 30 wt. %, more preferably between 0.4 and 20 wt. %, and most preferably between 0.8 and 10 wt. % of the enzyme protein. In such compositions, an enzyme stabilizer can be contained in the enzyme composition in an amount of from 0.05 to 35 wt. %, preferably 0.05 to 10 wt. %, based on the total weight.

The protein concentration can be determined using known methods, for example the BCA method (bicinchoninic acid; 2,2′-bichinolyl-4,4′-dicarboxylic acid) or the Biuret method. The active protein concentration is determined in this regard by titrating the active centers using a suitable irreversible inhibitor (e.g. phenylmethylsulfonylfluoride (PMSF) for proteases) and determining the residual activity.

As a further preferred optional component, a preferred washing agent composition includes 0.2 to 4 wt. %, preferably 0.5 to 3 wt. %, fragrance preparation.

In addition to the actual fragrances, the fragrance preparation includes, for example, solvents, solid carrier materials or stabilizers.

A fragrance is a chemical substance which stimulates the sense of smell. In order to be able to stimulate the sense of smell, it should be possible to at least partially distribute the chemical substance in the air, i.e. the fragrance should be volatile at 25° C. at least to a small extent. If the fragrance is very volatile, the odor intensity abates quickly. At a lower volatility, however, the smell is longer-lasting, i.e. it does not disappear as quickly. In one embodiment, the fragrance therefore has a melting point in the range of from −100° C. to 100° C., preferably from −80° C. to 80° C., more preferably from −20° C. to 50° C., in particular from −30° C. to 20° C. In another embodiment, the fragrance has a boiling point in the range of from 25° C. to 400° C., preferably from 50° C. to 380° C., more preferably from 75° C. to 350° C., in particular from 100° C. to 330° C.

Overall, in order to act as a fragrance, a chemical substance should not exceed a certain molecular weight since, if the molecular weight is too high, the required volatility can no longer be ensured. In one embodiment, the fragrance has a molecular weight of from 40 to 700 g/mol, more preferably from 60 to 400 g/mol.

The odor of a fragrance is perceived by most people as pleasant and often corresponds to the smell of, for example, flowers, fruits, spices, bark, resin, leaves, grasses, mosses and roots. Fragrances can thus also be used to overlay unpleasant odors or even to provide a non-smelling substance with a desired odor. It is possible, for example, to use individual odorant compounds, such as synthetic products of the ester, ether, aldehyde, ketone, alcohol and hydrocarbon types, as fragrances.

Preferably, mixtures of different fragrances are used, which together produce an appealing fragrance note. Such a mixture of fragrances may also be referred to as perfume or perfume oil. Perfume oils of this kind may also contain natural fragrance mixtures, such as those obtainable from plant sources.

For the prolongation of the fragrance effect, it has proven to be advantageous to encapsulate the fragrance. In a corresponding embodiment, at least some of the fragrance is used in encapsulated form (fragrance capsules), in particular in microcapsules. However, it is also possible to use the entire fragrance in encapsulated form. The microcapsules may be water-soluble and/or water-insoluble microcapsules. For example, melamine-urea-formaldehyde microcapsules, melamine-formaldehyde microcapsules, urea-formaldehyde microcapsules or starch microcapsules can be used. “Fragrance precursor” refers to compounds which release the actual fragrance only after chemical conversion/cleavage, typically by exposure to light or other environmental conditions such as pH, temperature, etc. Such compounds are often also referred to as fragrance storage substances or “pro-fragrances.”

The composition of some preferred flowable washing agent preparations, in which the weight ratio of alkyl ether sulfate to fatty acid is 2:1 to 1:3, preferably 1:1 to 1:2, can be derived from the following tables (amounts given in wt. % based on the total weight of the preparation, unless otherwise indicated).

| | Formula 1 | Formula 2 | Formula 3 | Formula 4 |
|---|---|---|---|---|
| Anionic and non-ionic surfactant | 13 to 48 | 13 to 48 | 35 to 45 | 35 to 45 |
| Alkyl ether sulfate | 4 to 8 | 4 to 8 | 4 to 8 | 5 to 7 |
| Fatty acid | 5 to 14 | 5 to 14 | 5 to 14 | 8 to 10 |
| Water | <20 | <15 | <15 | <10 |
| Misc. | to make | to make | to make | to make |
| | up to 100 | up to 100 | up to 100 | up to 100 |
| | Formula 6 | Formula 7 | Formula 8 | Formula 9 |
| Anionic and non-ionic surfactant | 13 to 48 | 13 to 48 | 35 to 45 | 35 to 45 |
| Alkyl ether sulfate | 4 to 8 | 4 to 8 | 4 to 8 | 5 to 7 |
| Fatty acid | 5 to 14 | 5 to 14 | 5 to 14 | 8 to 10 |
| Alkyl ethoxylate | 12 to 28 | 12 to 28 | 15 to 25 | 15 to 25 |
| Water | <20 | <15 | <15 | <10 |
| Misc. | to make | to make | to make | to make |
| | up to 100 | up to 100 | up to 100 | up to 100 |
| | Formula 11 | Formula 12 | Formula 13 | Formula 14 |
| Anionic and non-ionic surfactant | 13 to 48 | 13 to 48 | 35 to 45 | 35 to 45 |
| Alkyl ether sulfate | 4 to 8 | 4 to 8 | 4 to 8 | 5 to 7 |
| Fatty acid | 5 to 14 | 5 to 14 | 5 to 14 | 8 to 10 |
| Alkyl ethoxylate | 12 to 28 | 12 to 28 | 15 to 25 | 15 to 25 |
| Organic solvent | 15 to 42 | 20 to 40 | 20 to 40 | 22 to 35 |
| Water | <20 | <15 | <15 | <10 |
| Misc. | to make | to make | to make | to make |
| | up to 100 | up to 100 | up to 100 | up to 100 |
| | Formula 16 | Formula 17 | Formula 18 | Formula 19 |
| Anionic and non-ionic surfactant | 13 to 48 | 13 to 48 | 35 to 45 | 35 to 45 |
| Alkyl ether sulfate | 4 to 8 | 4 to 8 | 4 to 8 | 5 to 7 |
| Fatty acid | 5 to 14 | 5 to 14 | 5 to 14 | 8 to 10 |
| Alkyl ethoxylate | 12 to 28 | 12 to 28 | 15 to 25 | 15 to 25 |
| Organic solvent | 15 to 42 | 20 to 40 | 20 to 40 | 22 to 35 |
| Water | <20 | <15 | <15 | <10 |
| Phosphonate | 0.1 to 3 | 0.1 to 3 | 0.1 to 3 | 0.2 to 1 |
| Misc. | to make | to make | to make | to make |
| | up to 100 | up to 100 | up to 100 | up to 100 |
| | Formula 21 | Formula 22 | Formula 23 | Formula 24 |
| Anionic and non-ionic surfactant | 13 to 48 | 13 to 48 | 35 to 45 | 35 to 45 |
| Alkyl ether sulfate ¹⁾ | 4 to 8 | 4 to 8 | 4 to 8 | 5 to 7 |
| Fatty acid | 5 to 14 | 5 to 14 | 5 to 14 | 8 to 10 |
| Water | <20 | <15 | <15 | <10 |
| Misc. | to make | to make | to make | to make |
| | up to 100 | up to 100 | up to 100 | up to 100 |
| | Formula 26 | Formula 27 | Formula 28 | Formula 29 |
| Anionic and non-ionic surfactant | 13 to 48 | 13 to 48 | 35 to 45 | 35 to 45 |
| Alkyl ether sulfate ¹⁾ | 4 to 8 | 4 to 8 | 4 to 8 | 5 to 7 |
| Fatty acid | 5 to 14 | 5 to 14 | 5 to 14 | 8 to 10 |
| Alkyl ethoxylate | 12 to 28 | 12 to 28 | 15 to 25 | 15 to 25 |
| Water | <20 | <15 | <15 | <10 |
| Misc. | to make | to make | to make | to make |
| | up to 100 | up to 100 | up to 100 | up to 100 |
| | Formula 31 | Formula 32 | Formula 33 | Formula 34 |
| Anionic and non-ionic surfactant | 13 to 48 | 13 to 48 | 35 to 45 | 35 to 45 |
| Alkyl ether sulfate ¹⁾ | 4 to 8 | 4 to 8 | 4 to 8 | 5 to 7 |
| Fatty acid | 5 to 14 | 5 to 14 | 5 to 14 | 8 to 10 |
| Alkyl ethoxylate | 12 to 28 | 12 to 28 | 15 to 25 | 15 to 25 |
| Organic solvent | 15 to 42 | 20 to 40 | 20 to 40 | 22 to 35 |
| Water | <20 | <15 | <15 | <10 |
| Misc. | to make | to make | to make | to make |
| | up to 100 | up to 100 | up to 100 | up to 100 |
| | Formula 36 | Formula 37 | Formula 38 | Formula 39 |
| Anionic and non-ionic surfactant | 13 to 48 | 13 to 48 | 35 to 45 | 35 to 45 |
| Alkyl ether sulfate ¹⁾ | 4 to 8 | 4 to 8 | 4 to 8 | 5 to 7 |
| Fatty acid | 5 to 14 | 5 to 14 | 5 to 14 | 8 to 10 |
| Alkyl ethoxylate | 12 to 28 | 12 to 28 | 15 to 25 | 15 to 25 |
| Organic solvent | 15 to 42 | 20 to 40 | 20 to 40 | 22 to 35 |
| Water | <20 | <15 | <15 | <10 |
| Misc. | to make | to make | to make | to make |
| | up to 100 | up to 100 | up to 100 | up to 100 |
| | Formula 41 | Formula 42 | Formula 43 | Formula 44 |
| Anionic and non-ionic surfactant | 13 to 48 | 13 to 48 | 35 to 45 | 35 to 45 |
| Alkyl ether sulfate ¹⁾ | 4 to 8 | 4 to 8 | 4 to 8 | 5 to 7 |
| Fatty acid | 5 to 14 | 5 to 14 | 5 to 14 | 8 to 10 |
| Alkyl ethoxylate ²⁾ | 12 to 28 | 12 to 28 | 15 to 25 | 15 to 25 |
| Water | <20 | <15 | <15 | <10 |
| Misc. | to make | to make | to make | to make |
| | up to 100 | up to 100 | up to 100 | up to 100 |
| | Formula 46 | Formula 47 | Formula 48 | Formula 49 |
| Anionic and non-ionic surfactant | 13 to 48 | 13 to 48 | 35 to 45 | 35 to 45 |
| Alkyl ether sulfate ¹⁾ | 4 to 8 | 4 to 8 | 4 to 8 | 5 to 7 |
| Fatty acid | 5 to 14 | 5 to 14 | 5 to 14 | 8 to 10 |
| Alkyl ethoxylate ²⁾ | 12 to 28 | 12 to 28 | 15 to 25 | 15 to 25 |
| Organic solvent | 15 to 42 | 20 to 40 | 20 to 40 | 22 to 35 |
| Water | <20 | <15 | <15 | <10 |
| Misc. | to make | to make | to make | to make |
| | up to 100 | up to 100 | up to 100 | up to 100 |
| | Formula 51 | Formula 52 | Formula 53 | Formula 54 |
| Anionic and non-ionic surfactant | 13 to 48 | 13 to 48 | 35 to 45 | 35 to 45 |
| Alkyl ether sulfate ¹⁾ | 4 to 8 | 4 to 8 | 4 to 8 | 5 to 7 |
| Fatty acid | 5 to 14 | 5 to 14 | 5 to 14 | 8 to 10 |
| Alkyl ethoxylate ²⁾ | 12 to 28 | 12 to 28 | 15 to 25 | 15 to 25 |
| Organic solvent | 15 to 42 | 20 to 40 | 20 to 40 | 22 to 35 |
| Water | <20 | <15 | <15 | <10 |
| Phosphonate | 0.1 to 3 | 0.1 to 3 | 0.1 to 3 | 0.2 to 1 |
| Misc. | to make | to make | to make | to make |
| | up to 100 | up to 100 | up to 100 | up to 100 |

¹⁾ Alkyl ether sulfate selected from fatty alcohol ether sulfates of the formula R¹—O—(AO)ₙ—SO₃⁻ X⁺ (I), where R¹ = linear C12-18 alkyl, n = 2, 3, 4, 5, 6, 7 or 8 and X⁺ = Na ⁺ or HOCH₂CH₂NH₃⁺, in particular from the group of Na fatty alcohol ether sulfates or monoethanolamine fatty alcohol sulfates having 12 to 18 C atoms and 2 EO (R¹ = linear C12-18 alkyl, n = 2 in formula (I)).

²⁾ Alkyl ethoxylate from the group of ethoxylated primary C₈₋₁₈, preferably the C₁₂₋₁₄ alcohols having 4 EO or 7 EO, the C₉₋₁₁ alcohols having 7 EO, the C₁₃₋₁₅ alcohols having 5 EO, 7 EO or 8 EO, the C₁₃₋₁₅ oxo alcohols having 7 EO, the C₁₂₋₁₈ alcohols having 5 EO or 7 EO, in particular the C₁₂₋₁₈ fatty alcohols having 7 EO or the C₁₃₋₁₅ oxo alcohols having 7 EO.

The substance systems described above are not only suitable for ensuring simple manufacturability, good storability and cleaning performance, but also make it possible to implement a product appearance which is attractive to the consumer. Such washing agent preparations which are transparent and consequently have a low level of turbidity, for example, are perceived as visually attractive. Preferred washing agent preparations therefore have a turbidity (HACH Turbidimeter 2100Q, 20° C., 10 ml cuvette) below 100 NTU, preferably below 50 NTU and in particular below 20 NTU. At an NTU value (at 20° C.) of 60 or more, shaped bodies have a perceptible turbidity within the meaning of the invention, as can be seen with the naked eye.

Another group of washing agent preparations perceived as visually attractive are those which have a cloudy white appearance. The turbidity (HACH Turbidimeter 2100Q, 20° C., 10 ml cuvette) of corresponding preferred washing agent preparations is above 100 NTU and in particular above 400 NTU. Corresponding compositions preferably have an opacifying agent from the group of styrene-acrylate copolymers (INCI: styrene/acrylates copolymer) and inorganic salts, in particular from the group of inorganic salts.

The Nephelometric Turbidity Unit (NTU) is frequently used as an indication of transparency. It is a unit which is used, for example, in water treatment, for measuring turbidity, for example in liquids. It is a unit of turbidity measured using a calibrated nephelometer. High NTU values are measured for clouded compositions, whereas low values are determined for clear compositions.

The HACH Turbidimeter 2100Q from Hach Company, Loveland, Colo. (USA) is used with the calibration substances StabICal Solution HACH (20 NTU), StabICal Solution HACH (100 NTU) and StabICal Solution HACH (800 NTU), all of which can also be ordered from Hach Company. The measurement is filled with the composition to be analyzed in a 10 ml measuring cuvette having a cap and is carried out at 20° C.

The optical advantages of the concentrated washing agent preparations are particularly evident in packaging means, which, in turn, are transparent and allow a direct view of the washing agent composition. In addition to transparent plastics bottles, transparent pouches, in particular water-soluble transparent pouches, are therefore particularly preferred for assembly and packaging.

Another preferred subject of this application is therefore a washing agent portion unit comprising
i) a washing agent preparation according to the invention,
ii) a water-soluble film which completely encloses the washing agent preparation.

The water-soluble film in which the washing agent preparation is packaged can comprise one or more structurally different water-soluble polymer(s). Particularly suitable water-soluble polymer(s) include polymers from the group of (optionally acetalized) polyvinyl alcohols (PVAL) and the copolymers thereof.

Water-soluble films are preferably based on a polyvinyl alcohol or a polyvinyl alcohol copolymer of which the molecular weight is in the range of 10,000 to 1,000,000 gmol⁻¹, preferably of 20,000 to 500,000 gmol⁻¹, particularly preferably of 30,000 to 100,000 gmol⁻¹, and in particular of 40,000 to 80,000 gmol⁻¹.

The production of polyvinyl alcohol and polyvinyl alcohol copolymers generally includes the hydrolysis of intermediate polyvinyl acetate. Preferred polyvinyl alcohols and polyvinyl alcohols have a degree of hydrolysis of 70 to 100 mol. %, preferably 80 to 90 mol. %, particularly preferably 81 to 89 mol. %, and in particular 82 to 88 mol. %.

Polyvinyl alcohol copolymers which include, in addition to vinyl alcohol, an ethylenically unsaturated carboxylic acid, or the salt or ester thereof, are preferred. Polyvinyl alcohol copolymers of this kind particularly preferably contain, in addition to vinyl alcohol, sulfonic acids such as 2-acrylamido-2-methyl-1-propane sulfonic acid (AMPS), acrylic acid, methacrylic acid, acrylic acid ester, methacrylic acid ester or mixtures thereof, of the esters, C₁₋₄ alkyl esters or C₁₋₄ hydroxyalkyl esters are preferred. Other suitable monomers are ethylenically unsaturated dicarboxylic acids, for example itaconic acid, maleic acid, fumaric acid and mixtures thereof.

Suitable water-soluble films for use are sold, inter alia, by the company MonoSol LLC, for example under the names M8630, M8720, M8310, C8400 or M8900. Films having the names Solublon® PT, Solublon® GA, Solublon® KC or Solublon® KL from Aicello Chemical Europe GmbH, or the VF-HP films from Kuraray are also suitable.

The water-soluble films can contain additional active ingredients or fillers, but also plasticizers and/or solvents, in particular water, as further ingredients.

The group of further active ingredients includes, for example, materials which protect the ingredients of the preparation enclosed by the film material from decomposition or deactivation by light irradiation. Antioxidants, UV absorbers and fluorescent dyes have proven to be particularly suitable for this.

Glycerol, ethylene glycol, diethylene glycol, propanediol, 2-methyl-1,3-propanediol, sorbitol or mixtures thereof, for example, can be used as plasticizers.

To reduce its coefficient of friction, the surface of the water-soluble film of the washing agent portion unit can optionally be powder-coated with fine powder. Sodium aluminosilicate, silica, talc and amylose are examples of suitable powdering agents.

Preferred water-soluble films are suitable for processing in a deep-drawing apparatus.

The volume of the washing agent portion unit is preferably from 12 to 22 ml, in particular from 12 to 18 ml.

The washing agent portion unit according to one of the preceding points, wherein the washing agent portion unit has one to four receiving chambers, preferably three or four receiving chambers. In the case of washing agent portion units having two or more receiving chambers, preferably at least one of the receiving chambers, preferably the majority of the receiving chambers, is transparent.

A further subject of the application is a method for cleaning textiles, in which a previously described washing agent preparation or washing agent portion unit is introduced into the washing liquor of a textile washing machine.

In preferred method variants, the washing agent preparation or the washing agent portion unit is dosed directly into the drum or into the dispensing drawer of the textile washing machine.

The machine textile washing process is preferably carried out at temperatures from 20° C. to 60° C., preferably from 30° C. to 45° C.

This application provides the following subjects, inter alia:

1. A flowable washing agent preparation containing, based on the total weight thereof,
a) 4 to 8 wt. % alkyl ether sulfate;
b) 5 to 14 wt. % fatty acid;
c) less than 20 wt. % water;
   where
the total amount of anionic and non-ionic surfactants contained in the washing agent preparation is 13 to 48 wt. %; and
the washing agent preparation contains alkyl ether sulfate and fatty acid in a weight ratio of from 2:1 to 1:3.
   2. The washing agent preparation according to item 1, the total amount of the anionic and non-ionic surfactants contained in the washing agent preparation being 35 to 45 wt. %.
   3. The washing agent preparation according to one of the preceding points, the washing agent preparation containing, based on the total weight thereof, 5 to 7 wt. % alkyl ether sulfate.
   4. The washing agent preparation according to one of the preceding points, the washing agent preparation containing, as the alkyl ether sulfate, a fatty alcohol ether sulfate, preferably a fatty alcohol ether sulfate selected from fatty alcohol ether sulfates of formula R¹—O-(AO)ₙ—SO₃⁻X⁺ (I), where R¹=linear C12-18 alkyl, n=2, 3, 4, 5, 6, 7 or 8 and X⁺═Na⁺ or HOCH₂CH₂NH₃⁺.
   5. The washing agent preparation according to one of the preceding points, the washing agent preparation containing, as the alkyl ether sulfate, a fatty alcohol ether sulfate selected from fatty alcohol ether sulfates of formula R¹—O-(AO)ₙ—SO₃⁻X⁺ (I), where R¹=linear C12-18 alkyl, n=2, 3, 4, 5, 6, 7 or 8 and X⁺═Na⁺ or HOCH₂CH₂NH₃⁺, in particular from the group of Na fatty alcohol ether sulfates or monoethanolamine fatty alcohol sulfates where R¹=linear C12-18 alkyl and n=2.
   6. The washing agent preparation according to one of the preceding points, the washing agent preparation containing, based on the total weight thereof, less than 10 wt. %, preferably less than 5 wt. %, and in particular less than 2 wt. % C₈₋₁₈ alkylbenzene sulfonates.
   7. The washing agent preparation according to one of the preceding points, the washing agent preparation containing, based on the total weight thereof, 8 to 10 wt. % fatty acid.
   8. The washing agent preparation according to one of the preceding points, the fatty acid being selected from the group of caprylic acid, capric acid, lauric acid, myristic acid, palmitic acid, stearic acid, oleic acid, linoleic acid and mixtures thereof.
   9. The washing agent preparation according to one of the preceding points, the washing agent preparation containing alkyl ether sulfate and fatty acid in a weight ratio of from 1:1 to 1:2.
   10. The washing agent preparation according to one of the preceding points, the washing agent preparation containing, based on the total weight thereof, 12 to 28 wt. %, preferably 15 to 25 wt. %, non-ionic surfactant.
   11. The washing agent preparation according to point 10, the non-ionic surfactant being selected from the group of ethoxylated primary C₈₋₁₈ alcohols, preferably the ethoxylated primary C₈₋₁₈ alcohols having a degree of alkoxylation of >4, particularly preferably the C₁₂₋₁₄ alcohols having 4 EO or 7 EO, the C₉₋₁₁ alcohols having 7 EO, the C₁₃₋₁₅ alcohols having 5 EO, 7 EO or 8 EO, the C₁₃₋₁₅ oxo alcohols having 7 EO, the C₁₂₋₁₈ alcohols having 5 EO or 7 EO, in particular the C₁₂₋₁₈ fatty alcohols having 7 EO or the C₁₃₋₁₅ oxo alcohols having 7 EO.
   12. The washing agent preparation according to one of the preceding points, the washing agent preparation containing non-ionic surfactant and anionic surfactant in a weight ratio above 5:3, preferably above 3:2.
   13. The washing agent preparation according to one of the preceding points, the washing agent preparation containing, based on the total weight thereof, less than 15 wt. %, preferably less than 10 wt. %, of water.
   14. The washing agent preparation according to one of the preceding points, the washing agent preparation containing, based on the total weight thereof, 15 to 45 wt. %, preferably 25 to 45 wt. %, solvent.
   15. The washing agent preparation according to one of the preceding points, the washing agent preparation containing, based on the total weight thereof, 15 to 42 wt. %, preferably 20 to 40 wt. %, and in particular 22 to 35 wt. % organic solvent.
   16. The washing agent preparation according to point 15, the organic solvent being selected from the group of ethanol, n-propanol, i-propanol, butanols, glycol, propanediol, butanediol, methylpropanediol, glycerol, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol mono methyl ether, dipropylene glycol mono ethyl ether, methoxytriglycol, ethoxytriglycol, butoxytriglycol, 1-butoxyethoxy-2-propanol, 3-methyl-3-methoxybutanol, propylene-glycol-t-butylether, di-n-octylether and mixtures thereof, preferably from the group of propanediol, glycerol, ethanol and mixtures thereof.
   17. The washing agent preparation according to one of the preceding points, the washing agent preparation containing, based on the total weight thereof, 0.1 to 3 wt. %, preferably 0.2 to 1 wt. %, phosphonate.
   18. The washing agent preparation according to point 17, the phosphonate being selected from the group of hydroxy alkane phosphonates and/or amino alkane phosphonates, preferably from the group of amino alkane phosphonates and in particular from the group of ethylenediamine tetramethylene phosphonate (EDTMP) and diethylenetriamine pentamethylene phosphonate (DTPMP).
   19. The washing agent preparation according to one of the preceding points, the washing agent preparation containing, based on the total weight thereof, less than 2 to 8 wt. %, preferably 3 to 6 wt. %, enzyme preparation.
   20. The washing agent preparation according to one of the preceding points, the washing agent preparation containing, based on the total weight thereof, 0.2 to 4 wt. %, preferably 0.5 to 3 wt. %, fragrance preparation.
   21. The washing agent preparation according to one of the preceding points, the washing agent preparation having a turbidity (HACH Turbidimeter 2100Q, 20° C., 10 ml cuvette) above 100 NTU, preferably above 50 NTU and in particular above 20 NTU.
   22. A washing agent portion unit comprising
i) a washing agent preparation according to one of points 1 to 21
ii) a water-soluble film which completely encloses the washing agent preparation.
   23. The washing agent portion unit according to point 22, the washing agent portion unit having a volume of 12 to 22 ml, preferably 12 to 18 ml.
   24. The washing agent portion unit according to one of the preceding points, the washing agent portion unit having one to four receiving chambers, preferably three or four receiving chambers.
   25. A method for cleaning textiles, in which a flowable washing agent preparation according to one of points 1 to 21 or a washing agent portion unit according to one of points 22 to 23 is introduced into the washing liquor of a textile washing machine.

What is claimed is:

1. A flowable washing agent preparation containing, based on the total weight thereof,
a) 4 to 8 wt. % alkyl ether sulfate;
b) 5 to 14 wt. % fatty acid;
c) less than 20 wt. % water;
where
the total amount of anionic and non-ionic surfactants contained in the washing agent preparation is 13 to 48 wt. %; and
the washing agent preparation contains alkyl ether sulfate and fatty acid in a weight ratio of from 2:1 to 1:3.

2. The washing agent preparation according to claim 1, wherein the total amount of the anionic and non-ionic surfactants contained in the washing agent preparation is 35 to 45 wt. %.

3. The washing agent preparation according to claim 1, wherein the washing agent preparation contains, based on the total weight thereof, 5 to 7 wt. % alkyl ether sulfate.

4. The washing agent preparation according to claim 1, wherein the washing agent preparation contains, as the alkyl ether sulfate, a fatty alcohol ether sulfate.

5. The washing agent preparation according to claim 1, wherein the washing agent preparation contains, based on the total weight thereof, less than 10 wt. % C₈₋₁₈ alkylbenzene sulfonates.

6. The washing agent preparation according to claim 1, wherein the washing agent preparation contains, based on the total weight thereof, 8 to 10 wt. % fatty acid.

7. The washing agent preparation according to claim 1, wherein the washing agent preparation contains, based on the total weight thereof, 12 to 28 wt. % non-ionic surfactant.

8. The washing agent preparation according to claim 1, wherein the washing agent preparation contains, based on the total weight thereof, less than 15 wt. % of water.

9. A washing agent portion unit comprising
i) a washing agent preparation according to claim 1,
ii) a water-soluble film which completely encloses the washing agent preparation.

10. A method for cleaning textiles, in which a washing agent preparation according to claim 1 is introduced into the washing liquor of a textile washing machine.

11. The washing agent preparation according to claim 4, wherein the washing agent preparation contains, a fatty alcohol ether sulfate selected from fatty alcohol ether sulfates of formula R¹—O-(AO)ₙ—SO₃⁻X⁺ (I), where R¹=linear C12-18 alkyl, n=2, 3, 4, 5, 6, 7 or 8 and X⁺═Na⁺ or HOCH₂CH₂NH₃⁺.

12. The washing agent preparation according to claim 5, wherein the washing agent preparation contains, based on the total weight thereof, less than 5 wt. % C₈₋₁₈ alkylbenzene sulfonates.

13. The washing agent preparation according to claim 5, wherein the washing agent preparation contains, based on the total weight thereof, less than 2 wt. % C₈₋₁₈ alkylbenzene sulfonates.

14. The washing agent preparation according to claim 7, wherein the washing agent preparation contains, based on the total weight thereof, 15 to 25 wt. % non-ionic surfactant.

15. The washing agent preparation according to claim 8, wherein the washing agent preparation contains, based on the total weight thereof, less than 10 wt. % of water.

16. A washing agent portion unit according to claim 9 is introduced into the washing liquor of a textile washing machine.
